(19) United States
(12) Patent Application Publication
(10) Pub. No.: US 2009/0171603 A1
(43) Pub. Date: Jul. 2, 2009

(54) METHODS OF DETECTING SERIES ARCS IN ELECTRICAL SIGNALS

(76) Inventors: Sriram Changali, Kerala (IN); Vljaysai Prasad, Karnataka (IN); Cecil Rivers, JR., Hartford, CT (US); Pradeep Vijayan, Karnataka (IN)

Correspondence Address: General Electric Company;GE Global Patent Operation, PO Box 861, 2 Corporate Drive, Suite 648, Shelton, CT, 06484, US

(21) Appl. No.: 11/965,885

(22) Filed: Dec. 28, 2007

(51) Int. Cl. G06F 19/00

(52) U.S. Cl. 702/66

(57) ABSTRACT

A method of detecting a series arc fault in an alternating current electrical signal is provided. A method for detecting a series arc fault in an alternating current electrical signal, comprising: a) calculating discrete wavelet coefficients using a current signal as an input for the discrete wavelet coefficient calculations, and outputting discrete wavelet coefficient filtered output; b) subsampling the discrete wavelet coefficient filtered output and outputting a subsampled output; c) calculating critical variables from the subsampled output; d) determining from the critical variables whether a series arc fault is present in the current signal; and e) outputting an signal indicating that a series arc fault is present in the current signal, if substantially all of the critical variables meet a predetermined criteria.

### BACKGROUND OF THE INVENTION

1. Field of the Invention

The present disclosure is related to electrical systems. More particularly, the present disclosure is related to methods and systems for detecting arcs in alternating current (AC) electrical systems.

2. Description of Related Art

The electrical systems in residential, commercial, and industrial applications usually include a panel board for receiving electrical power from a utility source. The power is routed through the panel board to one or more current interrupters such as, but not limited to circuit breakers, trip units, and others.

Each current interrupter distributes the power to a designated branch, where each branch supplies one or more loads with the power. The current interrupters are configured to interrupt the power to the particular branch if certain power conditions in that branch reach a predetermined set point.

For example, some current interrupters can interrupt power due to a ground fault, and are commonly known as ground fault current interrupters (GFCIs). The ground fault condition results when an imbalance of current flows between a line conductor and a neutral conductor, which could be caused by a leakage current or an arcing fault to ground.

Other current interrupters can interrupt power due to an arcing fault, and are commonly known as arc fault current interrupters (AFCIs). Arcing faults are commonly defined into two main categories, series arcs and parallel arcs. Series arcs can occur, for example, when current passes across a gap in a single conductor. Parallel arcs can occur, for example, when current passes between two conductors.

Unfortunately, arcing faults may not cause a conventional circuit interrupter to trip. This is particularly true when a series arc occurs because the current sensing device is unable to distinguish between a series arc and a normal load current. Series arcing can cause fires inside residential and commercial building. The potential for fires from series arcs to occur increases as homes become older and electrical wiring deteriorates from age.

Accordingly, it has been determined by the present disclosure that there is a continuing need for current interrupters and methods for detecting series arc faults in AC electrical systems that overcome, alleviate, and/or mitigate one or more of the aforementioned and other deleterious effects of prior art systems.

### BRIEF SUMMARY OF THE INVENTION

An exemplary embodiment of the present invention is a method of detecting a series arc in an alternating current electrical signal that includes a) calculating discrete wavelet coefficients using a current signal as an input for the discrete wavelet coefficient calculations, and outputting discrete wavelet coefficient filtered output; b) subsampling the discrete wavelet coefficient filtered output and outputting a subsampled output; c) calculating critical variables from the subsampled output; d) determining from the critical variables whether a series arc fault is present in the current signal; and e) outputting an signal indicating that a series arc fault is present in the current signal, if substantially all of the critical variables meet a predetermined criteria.

In another exemplary embodiment of the present invention is another method of detecting a series arc in an alternating current electrical signal. The embodiment includes a computer program product comprising: a program storage device readable by a circuit interrupter, tangibly embodying a program of instructions executable by the circuit interrupter to perform a method of detecting a series arc fault in an alternating current electrical signal, the method including: a) calculating discrete wavelet coefficients using a current signal as an input for the discrete wavelet coefficient calculations, and outputting discrete wavelet coefficient filtered output; b) subsampling the discrete wavelet coefficient filtered output and outputting a subsampled output; c) calculating critical variables from the subsampled output; d) determining from the critical variables whether a series arc fault is present in the current signal; and e) outputting an signal indicating that a series arc fault is present in the current signal, if substantially all of the critical variables meet a predetermined criteria.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining several embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

Further, the purpose of the foregoing Paragraph Titles used in both the background and the detailed description is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Paragraph Titles are neither intended to define the invention or the application, which only is measured by the claims, nor are they intended to be limiting as to the scope of the invention in any way.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIGS. 1a, 1b and 1c illustrate three types of arc faults;

FIG. 2 illustrates an exemplary embodiment of a distinct waveform exhibited by a series arc fault plotted in signal vs. time graph format;

FIG. 3a illustrates a hardware functional block diagram of an exemplary embodiment of series arc fault detection of the present invention.

FIG. 3b illustrates a flowchart of an exemplary embodiment of the series arc fault detection of the present invention;

FIG. 4 illustrates a schematic of an arc fault current interrupter implementing an exemplary embodiment of a series arc fault detection of the present invention;

FIG. 5 illustrates a discrete wavelet transform decomposition process for exemplary embodiment of the present invention;

FIG. 6a illustrate a Discrete Wavelet Coefficient Tree for exemplary embodiment of the present invention;

FIG. 6b illustrate a Discrete Wavelet Coefficient Tree for another exemplary embodiment of the present invention, where the number of coefficients may be to levels determined a priori;

FIG. 7 illustrates a flowchart of an example of a wavelet coefficient calculation used to determine the presence of a series arc fault in a signal.

FIGS. 8a, 8b, 8c and 8d illustrate various exemplary embodiments of the mother wavelet;

FIG. 9 illustrates a flowchart of an exemplary method for detecting series arcing described herein;

FIG. 10 is another embodiment of a functional block diagram for an exemplary Discrete Wavelet Transform analysis for series arc fault detection of an electrical signal.

FIG. 11a illustrates an exemplary embodiment of a fundamental frequency component for a typical current signal;

FIG. 11b illustrates an exemplary embodiment of an arcing frequency component for a typical current signal;

FIG. 11c illustrates an exemplary embodiment of a fundamental frequency component for arcing current signal;

FIG. 11d illustrates an exemplary embodiment of an arcing frequency component for arcing current signal.

### DETAILED DESCRIPTION OF THE INVENTION

The present invention provides series arc fault interruption. An electric arc can be defined in various manners. In the context of the present invention, an exemplary definition of an electric arc is an electrical breakdown of a normally nonconductive media that produces a luminous electrical discharge, resulting from a current flowing through the normally nonconductive media such as air. The definition is provided for understanding and is not meant to limit the invention; other definitions of electrical arc are applicable as would be understood by one of ordinary skill in the art.

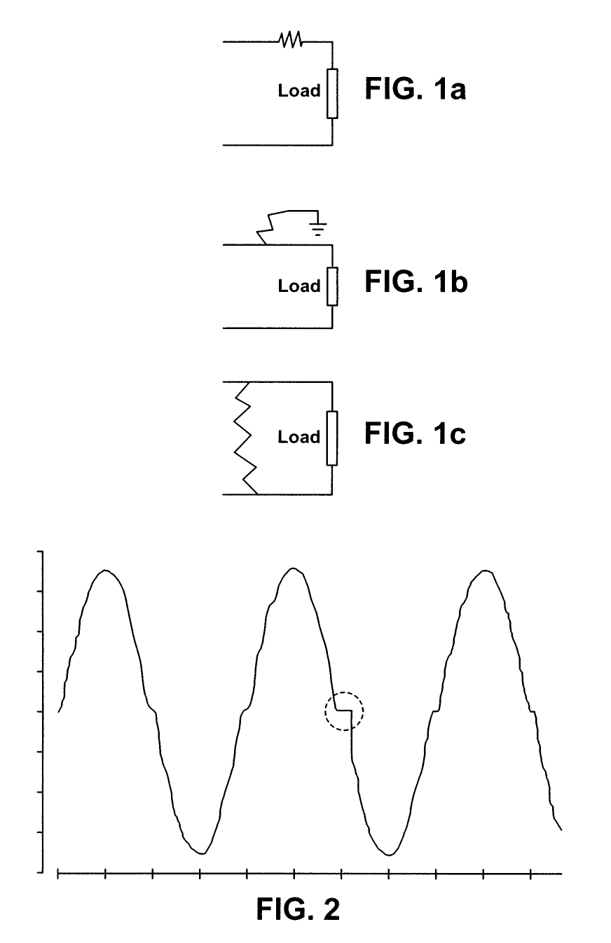

Referring to the drawings, and in particular to FIGS. 1a,b,c, illustrating three types of arc faults: 1) The series arc fault depicted in FIG. 1a; 2) The line to ground arc fault depicted in FIG. 1b and the parallel arc fault depicted in FIG. 1c. Exemplary embodiment(s) of the present invention described herein are directed to interruption of the series arc fault of FIG. 1a.

The exemplary embodiments of the present invention, described herein, focus on series arc fault detection. Also, embodiments of the present use a detection strategy to detect series arc faults. The series arc fault is in series with the load as illustrated in FIG. 1a; hence the arcing fault current values are lower than the normal RMS load current values. The present invention provides for arc fault pattern recognition to differentiate between series arc fault current and other non-arcing transient loads currents such as transients caused by, for example, dimmers, drills, fluorescent lamps etc.

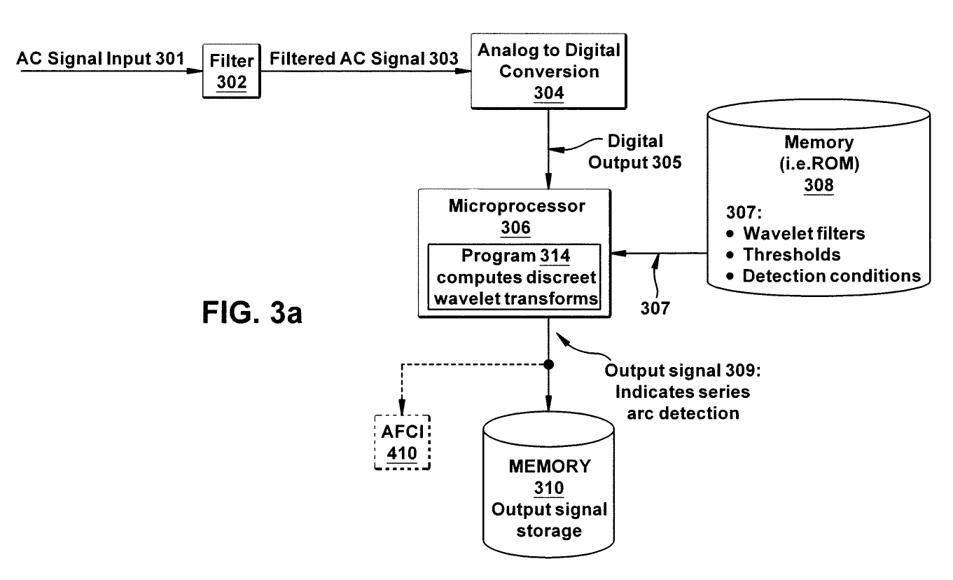

FIG. 2 illustrates an exemplary embodiment of a distinct waveform exhibited by a series arc fault plotted in signal vs. time graph format. A series arc fault current exhibits a distinct waveform, an example of which is illustrated in FIG. 2. When plotted as in FIG. 2, the series arc fault current includes shoulders, which are due to re-strike of the electrical arcing phenomenon. An exemplary shoulder of the waveform of FIG. 2 is illustrated inside a circular dashed line of FIG. 2.

Regarding re-strike, arcing is quenched near the zero crossing of the current waveform. Since the arcing is quenched, there is substantially no current flow. Additionally, a dielectric breakdown occurs at a series gap and a re-strike of the arcing current occurs by which the arcing current begins to flow again. The re-strike phenomenon is repeated across zero crossing of the current waveform. Generally, the re-strike phenomenon is referred to as re-ignition of the current waveform since the current is reignited as a result of dielectric breakdown of the conducting medium. In the case of the re-strike, the conducting medium is the series gap.

Regarding arcing frequency, a range can be determined for arcing frequencies of a given signal that includes a series arc fault. In an exemplary embodiment, a frequency domain analysis of the current signals using Short-Time FFT (Fast Fourier Transforms) and Wavelet transforms reveals that the arcing frequencies are positioned in a range defined between 700 Hz and 1500 Hz. These frequencies are associated with the re-ignition at the shoulders of the current waveform for a 50 Hz system. One of ordinary skill in the art would understand that the arcing frequency range would differ when the input signal current waveform is from a system other than 50 Hz, for example, a conventional 60 Hz U.S. frequency.

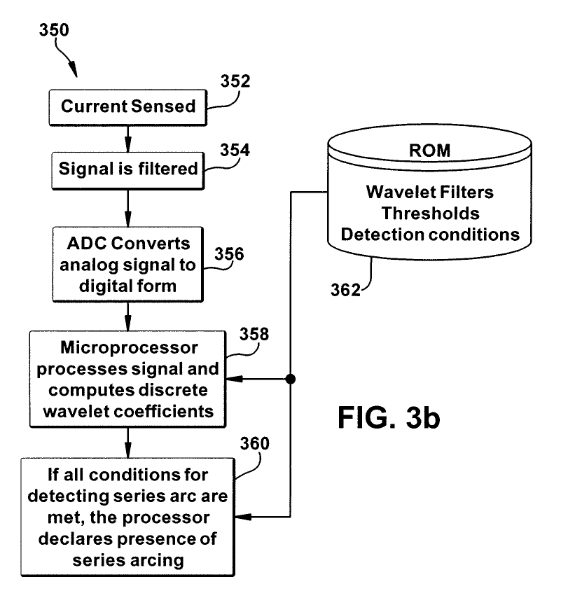

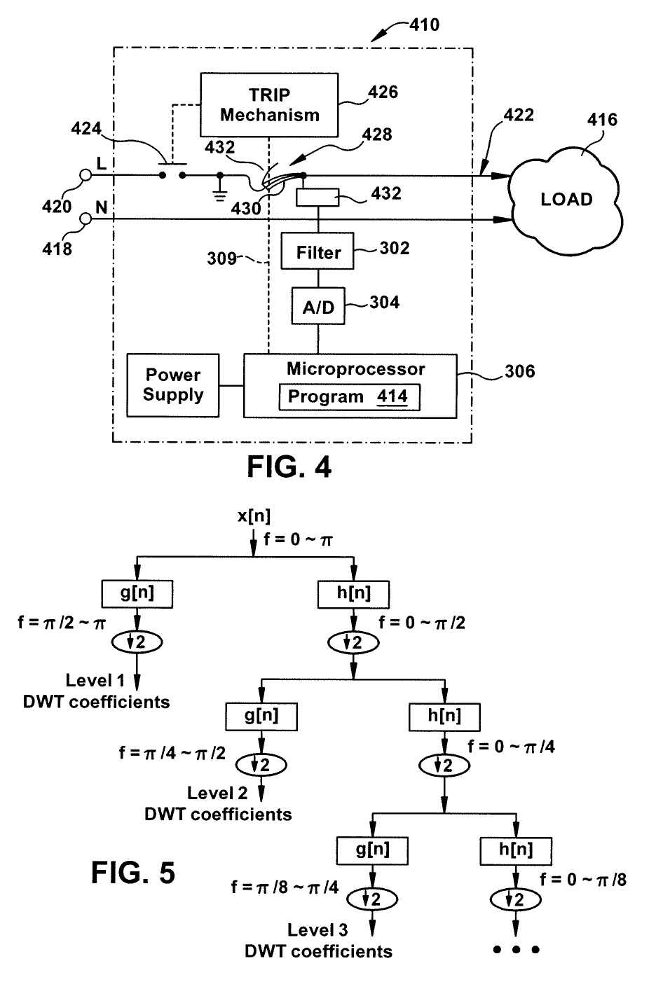

FIG. 3a illustrates a hardware functional block diagram 300 of an exemplary embodiment of series arc fault detection of the present invention. An alternating-current (AC) signal 301 is input to filter 302. A filtered signal 303 is output an analog to digital converter 304. The digital output 305 is then processed by microprocessor 306. Memory 308, for example read only memory (ROM), provides various data and programs 307 to microprocessor 306. The microprocessor 306 computes whether input signal 301 is includes a series arc fault signal. The microprocessor output 309 indicating that a series arc fault is present as determined by analysis of the input signal 301 can be provided to memory 310 (such as a re-writable memory storage device as may be determined by one of ordinary skill in the art) for storage and use at a later time. Alternately, as illustrated with dashed lines, output 309 may be provided to an AFCI 410, which is described below in an FIG. 4 below.

FIG. 4 illustrates a schematic of an arc fault current interrupter (AFCI) implementing an exemplary embodiment of a series arc fault detection of the present invention. FIG. 4, an exemplary embodiment of an arc fault current interrupter (AFCI) according to the present disclosure is shown and is generally referred to by reference numeral 410. AFCI 410 includes a microprocessor 306 having a series arc fault detection program 414 resident thereon.

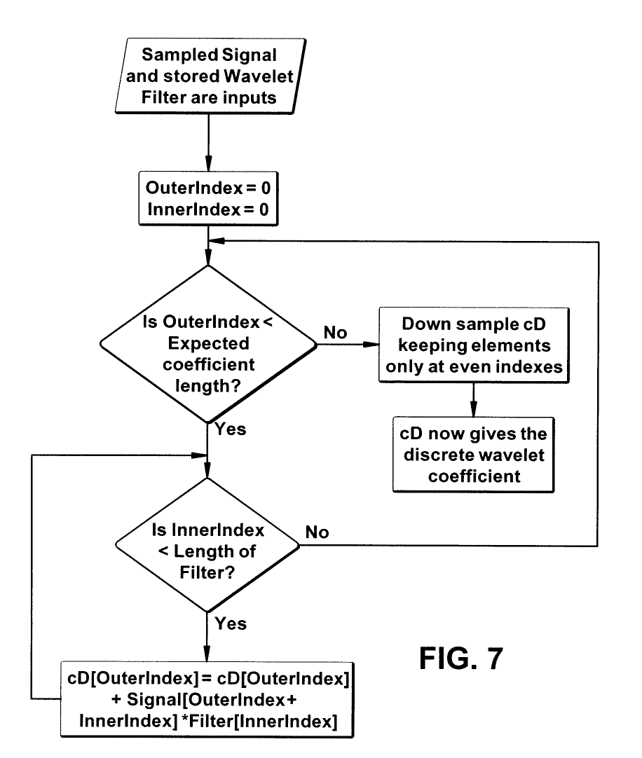

Advantageously, program 414, an exemplary embodiment of the present invention, uses a discrete wavelet transform approach to series arc detection. Program 414 determines one or more signal features that are considered frequencies of interest. Program 414 then processes the one or more signal features to calculate a plurality of discrete wavelet transforms. A decision tree program is provided with predetermined thresholds, wavelet filters, and detection conditions; the decision tree program calculating discrete wavelet transforms is used to determine the presence of series arc faults. An exemplary decision tree illustrating discrete wavelet transforms is discussed below in reference to FIGS. 6a,b.

The exemplary embodiment of AFCI 410 is configured to place in a load 416 in electrical communication with a neutral conductor 418 and a line conductor 420 across a branch circuit 422. AFCI 410, via program 414, is configured to selectively open separable contacts 424 across line conductor 420 upon detection of a series arc fault. In this manner, AFCI 410 is adapted to detect series arcing in branch circuit 422 and to interrupt power to the branch circuit.

Contacts 424 are opened by a trip mechanism 426 in a known manner. For example, contacts 424 can be opened by a spring loaded trip mechanism (not shown) as is known in the art.

In addition to being activated by program 414, trip mechanism 426 can also be actuated by a conventional thermal-magnetic overcurrent device 428 having a bimetal 430 connected in series with line conductor 420. For example, bimetal 430 can bend in a known manner upon application of an overcurrent to the bimetal, which results in activation of trip mechanism 426. Additionally, bimetal 430 can include a magnetically actuated armature 432, which can activate trip mechanism 426 upon application of short circuits across the bimetal.

In some exemplary embodiments, AFCI 410 can include a conventional parallel arc detector 432. Parallel arc detector 432 is configured to activate trip mechanism 426 upon detection of parallel arcs across line conductor 420. Thus, program 414 of the present disclosure can work in parallel with the existing AFCI parallel arc detection or separate from the existing AFCI detection.

In this manner, the exemplary embodiment of AFCI 410 combines overcurrent device 428, which provides overcurrent and short protection, parallel arc fault detector 432, which provides parallel arc fault detection, and in an exemplary embodiment of the present invention, program 414, which provides series arc fault detection.

AFCI 410 of FIG. 4 and the functional block diagram of FIG. 3a each include filter 302 with a filtered output signal 303. An example of filtering performed in an embodiment of the present invention, filter 302 is a Butterworth low pass filter with a flat pass-band of 50 Kz. A low-pass digital filter with cut-off frequency of 50 KHz was implemented to ensure that the high frequency noise was removed and that the sampled signal contained substantially only the fundamental component and the arcing component. The filter can be an analog hardware filter or a digital filter, as may be determined to by one of ordinary skill in the art. The microprocessor samples the input signal at for example, 50 kHz and uses that portion to perform discrete wavelet transform. Therefore, in the above-described exemplary sampling, the optimal sampling frequency is 50 KHz.

FIG. 4 also corresponds to the flowchart 350 of FIG. 3b, which illustrates an exemplary embodiment of the method of the present invention. At 352 current is sensed. At 354 the signal is filtered, for example to remove noise. At 356 the signal is converted from analog to digital. At 358, the microprocessor processes the signal using discrete wavelet transform mathematics and computes discrete wavelet coefficients. AT 350, if substantially all conditions for detecting a series arc fault are met, then the microprocessor signals the presence of a series arc fault in the input signal of 352. Memory, for example, ROM memory interacts with the microprocessor with respect to for example, wavelet filters, thresholds and detection conditions.

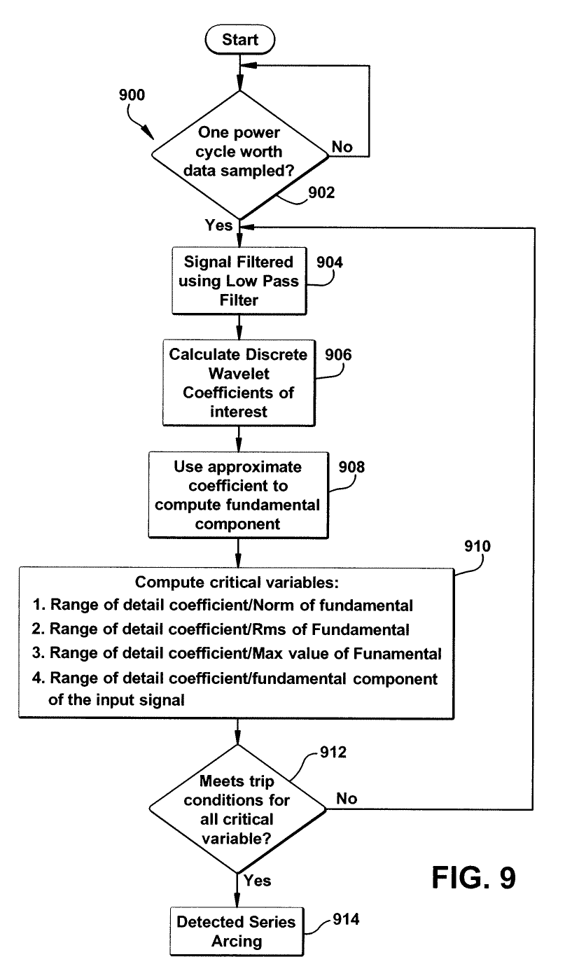

Various windowing strategies were considered, where a window is considered a region of interest and window sizing and other factors are considered as would be understood by one of ordinary skill in the art. The result of the strategic study is that a one-cycle-one-window strategy is optimum for the exemplary embodiment described herein. Therefore, the input signal to the discrete wavelet transform is a single cycle and corresponds to the one-cycle-one-window strategy. For example, for the one power cycle worth of data sample (902 of FIG. 9), the window is 1 cycle long where for 60 Hz standard frequency the window is a signal of 0.0167 seconds in length and for 50 Hz standard frequency the window is a signal of 0.0200 seconds in length. One of ordinary skill in the art can determine an appropriate sample size.

Returning to the exemplary embodiment of FIG. 3, the digital signal output 306 is used in microprocessor 306, which runs program 314, a discrete wavelet transform program. The program 314 outputs discrete wavelet coefficients. Memory 308 provides various data and programs 307 including wavelet filters, predetermined thresholds and detection conditions to microprocessor 306. The microprocessor 306 computes discrete wavelet coefficients using discrete wavelet transforms and determines whether input signal 301 includes a series arc fault signal.

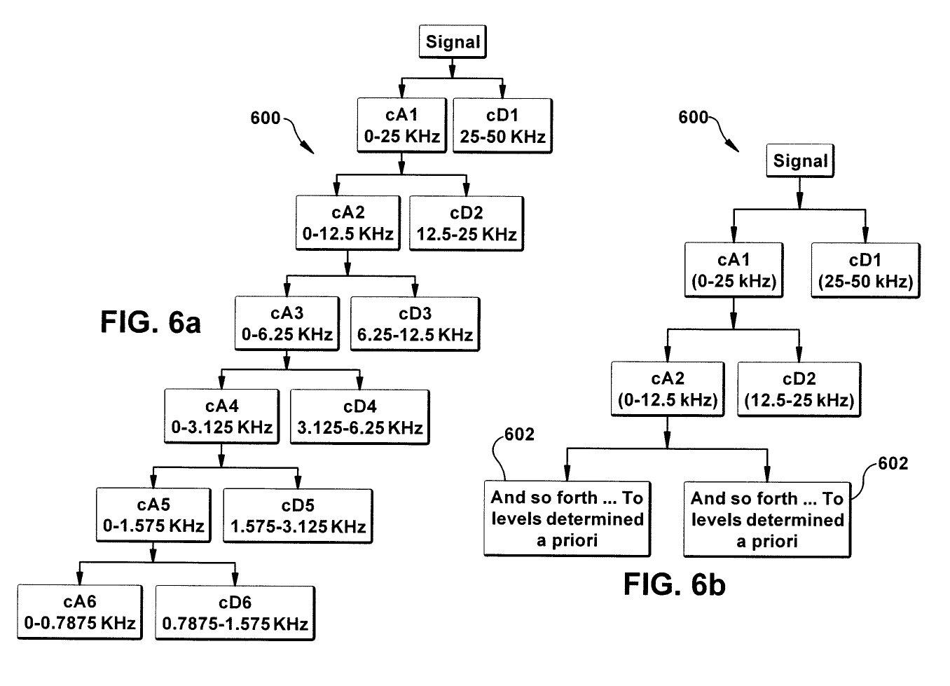

Discrete Wavelet Transforms. The microprocessor 306 of FIG. 3 runs program 314 which using Discrete Wavelet Transforms (DWT) computes discrete waveform coefficients illustrated, for example, in FIG. 5. A wavelet is mathematical function that divides a given signal into various frequency components and analyzes each frequency component with a resolution that matches its scale. A wavelet transform is the representation of a signal by wavelets. In the case of the discrete wavelet transform, the wavelets are a fast-decaying oscillating waveform known as the mother wavelet. Wavelet transforms have advantages over traditional Fourier transforms because they can represent signals having discontinuities and sharp peaks, and can accurately deconstruct and reconstruct finite, non-periodic and/or non-stationary signals.

Essentially, the discrete wavelet transform uses digital filters, as well as sufficient time resolution, to analyze various frequency components of a digital signal 305. While using the DWT on a signal, the signal is passed through a series of high pass filters to analyze high frequencies and a series of low pass filters to analyze the low frequencies.

When DWT is used on a signal, two operations are performed to compute DWT coefficients; these operations are sub-sampling and filtering. Filtering changes the resolution of the signal whereas sub-sampling, including up-sampling and down-sampling, changes the scale of the signal response.

Discrete Wavelet Coefficient Calculation. In the example of the present embodiment of the invention, discrete wavelet coefficient calculation begins with a discrete time signal x[n], also known as the digital signal 305 which is input to microprocessor 306 in an exemplary embodiment of the invention illustrated in FIG. 3. The discrete wavelet coefficient calculation(s) are first performed to provide a decomposition of the signal x[n].

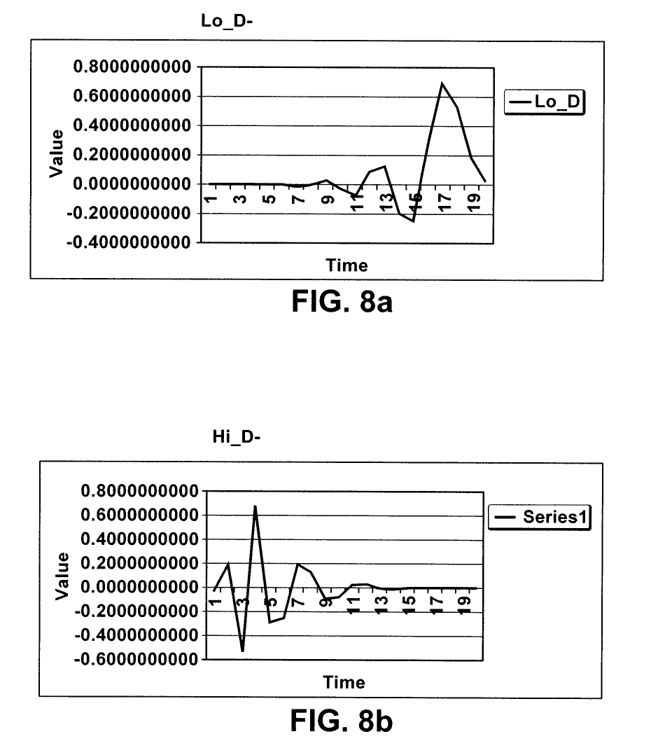

Regarding the discrete wavelet coefficients, there are two sets of filter coefficients. A filter is generally referred to herein in a format filter[ ], i.e. h[n] for filter h at index n where n=1, 2, 3, 4, . . . n+1. There are two sets of filter coefficients: 1) one set of filter coefficients for Decomposition, represented by Hi_D and Lo_D; and 2) one set of filter coefficients for signal reconstruction, represented by Hi_R and Lo_R. Both reconstruction and decomposition functions of the discrete wavelet transform calculation use the same convolution illustrated in the flowchart of FIG. 7 and the equations (1), (2), (3) and (4) described herein.

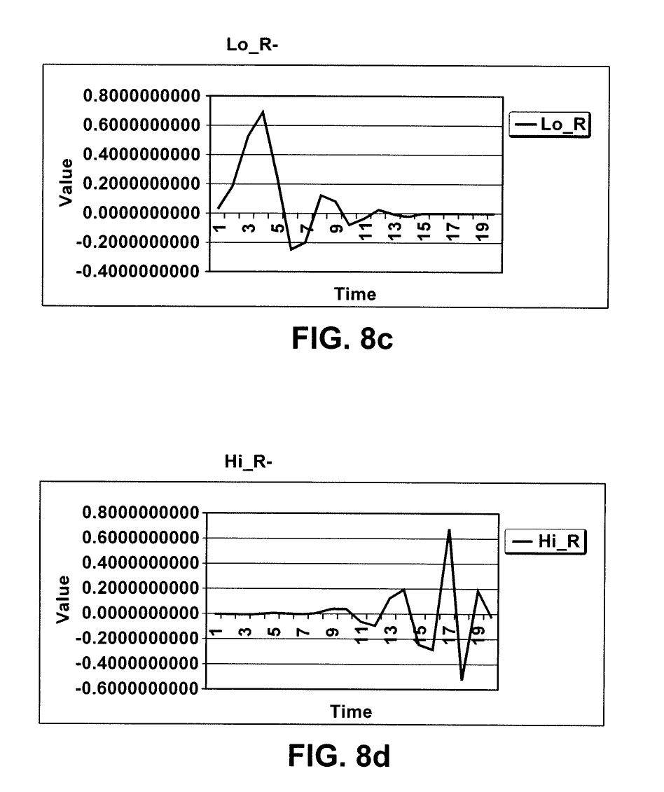

A distinction between the decomposition convolution and the reconstruction convolution is the filter variable (filter[ ]) used at each level. The filter variable (filter[ ]) can be either g[n] or h[n] where g[n] and h[n] are Hi_D and Lo_D, respectively, for decomposition. The filter variable (filter[ ]) can be either g[n] or h[n] where g[n] and h[n] are Hi_R and Lo_R for reconstruction, respectively. FIGS. 8a, 8b, 8c and 8d illustrate various embodiments of the mother wavelet. Discrete wavelet coefficients are calculated using equations (1) and (2) discussed herein, for each level ‘n’. One of ordinary skill in the art would understand that various discrete wavelet coefficient values can be calculated depending upon the level required and the frequency of interest.

Filtering. Firstly, calculating the coefficients involves passing this signal through a half band low pass digital filter with impulse response h[n]. This can be expressed mathematically in equation (1).

$$Low Pass \text{:} {x}_{low} [ n ] = x [ n ] ⋆ h [ n ] = {\sum }_{k = - ∞}^{∞} x [ k ] \cdot h [ n - k ] \qquad ( 1 )$$

Secondly, the signal is also passed through a half band high pass digital filter with impulse response g[n], and is mathematically represented by equation (2).

$$High Pass \text{:} {x}_{high} [ n ] = x [ n ] ⋆ g [ n ] = {\sum }_{k = - ∞}^{∞} x [ k ] \cdot g [ n - k ] \qquad ( 2 )$$

Scaling. After the filtering process of equations (1) and (2), signal resolution is halved while scale remains unchanged. The process of halving the scale is, for example, represented by equations (3) and (4), as follows:

$$\begin{matrix}Resolution \text{:} {y}_{high} [ k ] = {\sum }_{n} {x}_{high} [ n ] \cdot g [ 2 k - n ] ; & ( 3 ) \\ and & \\ Resolution \text{:} {y}_{low} [ k ] = {\sum }_{n} {x}_{low} [ n ] \cdot h [ 2 k - n ] & ( 4 )\end{matrix}$$

Filter outputs y_{high} and y_{low} are the result of the high pass and low pass filters, respectively, and the sub-sampling resolution changes that are the result of equations (3) and (4).

The results of equations (3) and (4) include that: 1) the time resolution is halved since only half the number of samples remain in the signal; and 2) the frequency resolution doubles since the signal retains only half the frequency band, and the frequency uncertainty is halved.

The calculations of equations (3) and (4), known as DWT decomposition process, may be performed for one iteration or the calculations may be repeated, as shown in FIG. 5, for “n” levels to obtain a desired time resolution and a desired frequency resolution. The level “n” may be determined by one of ordinary skill in the art in consideration of factors such as the time and frequency resolutions desired.

An exemplary decomposition of a sample signal, such as digital signal 305 input to microprocessor 306, uses mother wavelet variations illustrated in FIGS. 8a, 8b, 8c and 8d. The mother wavelet is further discussed below. The exemplary mother wavelet is 10 Debauchies in signal magnitude. The exemplary decomposition level n of the embodiment is illustrated in FIG. 6a. A general wavelet coefficient tree for decomposition calculation(s) is illustrated in FIG. 6b.

The overall approach explained mostly above, is represented by the flowchart of FIG. 9. The overall approach 900 of the exemplary discrete wavelet transform method 902 of the present invention begins with determining whether the input current signal 301 is a signal of appropriate window size at 904. In the present example, the query is whether one power cycle of data is provided in the current signal input; this one power cycle corresponds to the exemplary windowing strategy discussed herein of one cycle per window. If the appropriate data sample is provided then the signal can be processed in the discrete wavelet transform method. Next at operator 906, the signal is filtered to remove undesired components using, for example filer 302 of FIG. 3a. The signal output from filter 302 is next used in calculation(s) of discrete wavelet coefficients. The discrete wavelet coefficient calculation(s) begin with a discrete time signal x[n], also known as the digital signal 305 which is input to microprocessor 306 in an exemplary embodiment of the invention illustrated in FIG. 3. Next, at operator 908 approximate coefficients decomposed to a certain level computes a fundamental component of the AC signal input 301 (i.e. level 6). Next at 910, critical variables are computed including for example, ratios as follows: 1) a first critical variable substantially equal to the range of detail coefficient divided by a norm of the fundamental component; 2) a second critical variables substantially equal to the range of detail coefficient divided by an RMS value of the fundamental component; and 3) a third critical variables substantially equal to the range of detail coefficient divide by a maximum value of the fundamental component; and 4) a fourth critical variable substantially equal to a range of detail coefficient divided by a fundamental component of the input signal. Next at 912 a query is made as to whether the critical ratios meet the trip conditions. If all critical ratios meet trip conditions, then next at 914, a determination is made that series arc fault is detected. Alternately, if the critical ratios do not all meet trip conditions, then series arc fault is not detected.

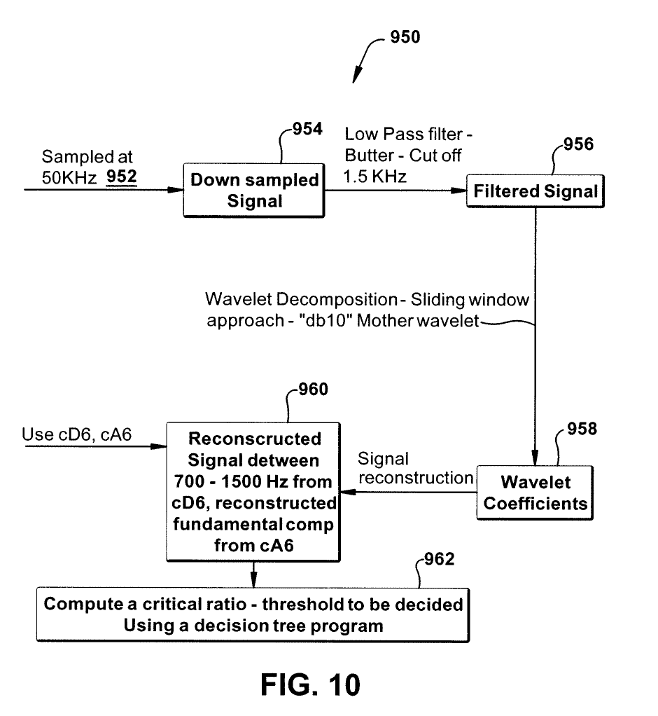

FIG. 10 is another embodiment of a functional block diagram 950 for an exemplary Discrete Wavelet Transform analysis for series arc fault detection of an electrical signal. The block diagram illustrates an electrical input signal 952 sampled at 50 KHz. At 954 the electrical input signal is down sampled and at 956 the signal if filtered. The signal is filtered using for example a low pass filter butter-cutoff of 50 KHz, also described with respect to FIG. 3. Next at 958 the signal is processed to obtain wavelet coefficients. This involves wavelet decomposition, a sliding window approach and an exemplary 10 Debauchies mother wavelet (illustrated in FIG. 8). After calculation of the wavelet coefficients, signal reconstruction occurs at 960. The exemplary reconstructed signal between 700 Hz and 1500 Hz is reconstructed from exemplary discrete wavelet coefficient cD6 (illustrated in FIG. 6a); the result of the reconstruction is a fundamental component from cA6. Next, at 962, a critical ratio is calculated wherein the threshold for the critical ratio is determined using a decision tree program. The critical ratio is used in analysis of the input signal to determine whether a series arc fault current signal is present in the input signal.

Mother Wavelet. It should be noted prior to discussing the mother wavelet that the mother wavelet is part of a set of wavelets known as Daubechies wavelets. Debauchies wavelets are a family of orthogonal wavelets defining a discrete wavelet transform (DWT) and characterized by a maximum number of vanishing moments for a given signal that is the subject of the discrete wavelet transform (DWT). The mother wavelet can be chosen by one of ordinary skill in the art considering factors such as 1) the shape of the signal (i.e. sinusoidal); 2) the frequency range of concern; and 3) empirical data obtained from pre-captured waveform(s). One of ordinary skill in the art may also study vanishing points (or vanishing moments) of the mother wavelet to obtain the signal measurement of the mother wavelet.

In an exemplary embodiment, a study of the factors 1) through 3) above and the number of vanishing points or vanishing moments in the mother wavelet revealed that the ideal mother wavelet is Daubechies 10. The approximate shape of the Daubechies 10 exemplary mother wavelet is illustrated in FIG. 8.

FIG. 6a illustrates wavelet coefficient tree 600 where at each level, i.e., 1 through 6, the wavelet coefficients cA or Approximate coefficient; and cD or Detailed coefficient are represented. The frequency range, i.e. 700 to 1500 KHz, corresponding to the wavelet coefficients is also represented.

This wavelet coefficient tree corresponds to an exemplary sampling frequency of 50 KHz, explained above. The last “n” level or final coefficients, cAn and cDn) are the coefficients of interest for the discrete wavelet transform process in general, as shown in FIG. 6b, and specifically for the wavelet coefficient calculation of the example embodiment of FIG. 6a.

The coefficients cAn and cDn are used in the exemplary signal reconstruction explained below. One of ordinary skill in the art can determine the appropriate “n” level coefficient to calculate, as illustrated in the FIG. 6b general wavelet coefficient tree with a last or “n” level determined a priori at 602.

The filters g[n] and h[n] discussed above are Quadrature Mirror Filters (QMF). FIGS. 8a, 8b, 8c and 8d illustrate various exemplary embodiments of the mother wavelet. Filters h[ ] and g[ ] and the mirror equation are used to obtain the discrete wavelet coefficients illustrated in the mother wavelet FIGS. 8a-8d. Quadrature Mirror Filters (QMF) and are related in the following way:

QMF Relationship: g[L−n−1]=(−1)ⁿ.h[n] (5)

Signal reconstruction is performed using equation (6) repeatedly for various levels “n”, as may be determined by one of ordinary skill in the art.

$$Signal Reconstruction \text{:} x [ n ] = {\sum }_{k = - ∞}^{∞} ( {y}_{high} [ k ] \cdot g [ - n + 2 k ] ) + ( {y}_{low} [ k ] \cdot h [ - n + 2 k ] ) \qquad ( 6 )$$

Signal reconstruction is substantially complete when the result is, for example, reconstructed time-domain signals including with a signal with the fundamental frequency component of 50 Hz and a signal with the arcing frequency band of 700 Hz to 1500 Hz, which is substantially equal to the signal that was decomposed.

The sampled, decomposed signal is reconstructed as explained above. Then, the range of this signal is normalized using the following: 1) Norm of the fundamental signal; 2) RMS of the fundamental signal; and 3) Maximum value of the fundamental signal. The ratios or critical ratios are used with a decision tree to make a determination of a trip/no trip decision when there is a determination of whether a series arc fault signal is present in the input signal. Critical ratios are 1) a first critical variable substantially equal to the range of detail coefficient divided by a norm of the fundamental component; 2) a second critical variables substantially equal to the range of detail coefficient divided by an RMS value of the fundamental component; 3) a third critical variables substantially equal to the range of detail coefficient divide by a maximum value of the fundamental component; and 4) a fourth critical variable substantially equal to a range of detail coefficient divided by a fundamental component of the input signal. The ratios are processed using decision tree software to obtain a decision tree. Analysis reveals a discrimination accuracy of up to substantially 100% for various loads including masking loads, where masking load can be for example a dimmer load that masks a series arc fault current.

Fast Fourier Transform analysis confirms that the frequency range of interest to detect the re-ignition at the shoulders, for the example series arc fault discussed herein, is 700 Hz-1500 Hz. FIG. 6a is a wavelet coefficient tree corresponding to an exemplary sampling frequency of 50 KHz. The final coefficients of interest to are represented in the final level “n”, with coefficients cAn or cA6 and cDn or cD6. These coefficients are used for the final signal reconstruction.

An exemplary embodiment of series arc fault discrete wavelet coefficient calculation is provided below. FIG. 7 corresponding to the below calculations is a flowchart that illustrates an example of a wavelet coefficient calculation used to determine the presence of a series arc fault in a signal such as input digital signal 30.

Series Arc Fault Detection—Discrete Wavelet Coefficient Calculation: The calculation is explained below in sections titled: A. VARIABLES USED; B. FUNCTION—DETAILS; C. FUNCTION—COEFFICIENT; D. FUNCTION—EXTENDED SIGNAL; E. FUNCTION—RESTRUCTURED SIGNAL; F. FUNCTION—RESTRUCTED ARRAY; G. CONVOLUTION—EQUATION.

A. Variables Used:

Lo_D—Low pass decomposition filter—array of size 20

Hi_D—High pass decomposition filter—array of size 20

Lo_R—Low pass reconstruction filter—array of size 20

Hi_R—High pass reconstruction filter—array of size 20

Create an array L [ ] to store the length of the elements in C [ ].
L [ ]=[length(cA6), length(cD6), length(cD5), length(cD4), length(cD3), length(cD2), length(cD1)]

B. Function—Details:

Function [cD, cA]=dwt (s, Lo_D, Hi_D)

s->input signal

Method:
1. length_filter=length(Lo_D)
   length_input=length(s);
2. lenEXT=length_filter−1;
   lenKEPT=length_input+length_filter−1;
3. Extend the array:
   y=extend (s, lenEXT); ->we perform a symmetric extension
4. Compute the approximate coefficients using the extended signal
   cA=convolutedown (y, Lo_D, lenKEPT);
5. Compute the detail coefficients using the extended signal
   cD=convolutedown (y, Hi_D, lenKEPT);
6. return cD, cA

C. Function—Coefficient:

Function [coefficient]=convolutedown (y, filter, length);

Method:
1. Convolute the signal y with the filter to obtain new y.
2. Keep only “length” number of elements at the center of the convoluted signal y.
3. Down sample y keeping only elements at even indexes.
4. return y

D. Function—Extended Signal:

Function [extended signal]=extend (s, lenEXT);
This function makes the data points symmetrical and extends the length by—“lenEXT”.
Example s[ ] has 50 elements.
lenEXT in our case will always be 19, since the length of our filter is 20.

The new array will look like this:

$$\begin{matrix}\begin{matrix} new array [ 1 ] = s [ 19 ] \\ new array [ 2 ] = s [ 18 ] \\ new array [ 3 ] = s [ 17 ] \\ ⋮ \\ ⋮ \\ ⋮ \\ ⋮\end{matrix} \\ \begin{matrix} new array [ 19 ] = s [ 1 ] \\ new array [ 20 ] = s [ 1 ] \\ new array [ 21 ] = s [ 2 ] \\ new array [ 22 ] = s [ 3 ] \\ ⋮ \\ ⋮ \\ ⋮ \\ \begin{matrix} new array [ 69 ] = s [ 50 ] \\ new array [ 70 ] = s [ 49 ] \\ new array [ 71 ] = s [ 48 ] \\ new array [ 72 ] = s [ 47 ] \\ ⋮ \\ ⋮ \\ ⋮ \\ ⋮ \\ new array [ 85 ] = s [ 35 ] \\ new array [ 86 ] = s [ 34 ] \\ new array [ 87 ] = s [ 33 ] \\ new array [ 88 ] = s [ 32 ] ; ; 32 = 50 - 19 + 1 \\ Total number of elements in new array = number of elements in original \\ array + 38.\end{matrix}\end{matrix}\end{matrix}$$

E. Function—Restructed Signal:

Function [reconstructed signal]=wav_reconstruct_coeff (mode, L);

Method:

| | |
|---|---|
| 1. | rmax = length (L); |
| 2. | nmax = rmax − 2; |
| 3. | if mode == a , nmin = 0 |

| | else nmin = 1 |
|---|---|
| 4. | switch mode |

case ‘a’:

x = cA6;
F1 = Lo_R;

case ‘d’:

x = cD6;
F1 = Hi_R;

| | |
|---|---|
| 5. | imin = rmax − 6; |

| 6. | x = upsample_convolute (x,F1, L ( imin+1 ) ); |
|---|---|
| 7. | for k = 2 to 6 , x = upsample_convolute (x, Lo_R, L |
| | ( imin+k ) ); |
| 8. | return x |

F. Function—Restructed Array:

Function [reconstructed array]=upsample_convolute (x, filter, length);

Method:

| 1. | if ( isempty ( x ) == TRUE) |
|---|---|
| | y = NULL; |
| | return y |
| 2. | y = x; Up sample “y” by inserting 0's in the even indices. |

| | |
|---|---|
| 3. | Convolute y with “filter” |
| 4. | Keep only “length” number of elements at the center |

of array “y”, discard the rest.

| | |
|---|---|
| 5. | return y |

G. Convolution—Equation:
Convolution: Δn exemplary convolution of two arrays f and g may be defined as:

$$( f * g ) ( m ) = {\sum }_{n} f ( n ) g ( m - n ) \qquad ( 7 )$$

Wavelet Transform Validation: The wavelet transform approach of the present invention can be validated using pre-captured waveforms and running Data using a mathematical modeling program. The results of the mathematical modeling program can be processed using a decision tree program in order to obtain a decision tree. The following is a brief summary of the exemplary validation method performed on the exemplary data discussed above. 1) Sampled signal decomposed using Debauchies 10 to level 6; 2) Signal reconstructed for frequency range 750-1500 Hz; 3) Normalization of the reconstructed signal using the norm, RMS and maximum values of the fundamental signal; and 4) Using the critical ratios to come to a trip/no trip decision using a decision tree.

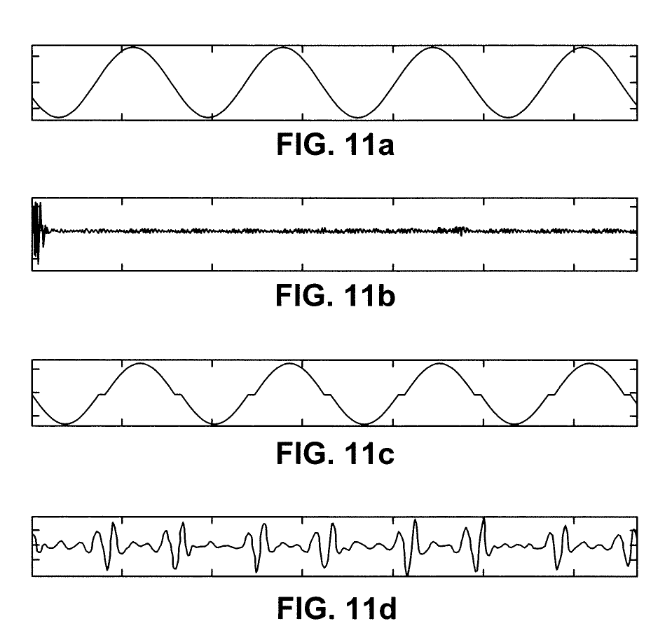

Several figures are provided to illustrate various components of arcing and nonarching time domain signals of the exemplary embodiment described above. FIG. 11a illustrates the fundamental component (50 Hz) for the non-arcing time-domain signal. FIG. 11b illustrates the arcing component (700 Hz to 1500 Hz) for the non-arcing time-domain signal. FIG. 11c illustrates the fundamental component (50 Hz) for the arcing time-domain signal. FIG. 11d illustrates the arcing component (700 Hz to 1500 Hz) for the arcing time-domain signal. From review and comparison of FIGS. 11a through 11d, a distinct difference between the arcing and the non-arcing signals can be seen. In the case of loads like drill, dimmer etc. the concept of looking for the arcing frequencies at the zero crossing of the fundamental signal further enhances the process of discrimination.

A decision can be obtained for various arcing and nonarcing current signal inputs to the microprocessor using a windowing strategy of one cycle per window as with the exemplary embodiment described above. For example, for the one power cycle worth of data sample (902 of FIG. 9), the window is 1 cycle long where for 60 Hz standard frequency the window is a signal of 0.0167 seconds in length and for 50 Hz standard frequency the window is a signal of 0.0200 seconds in length. One of ordinary skill in the art can determine an appropriate sample size/windowing technique. The resolution between arcing and non-arcing cases is substantially 100% with the one cycle per window strategy. Thus even visually there is a marked difference between the arcing and the non-arcing cases.

Real Time Validation. In an alternate embodiment of the present invention, real time validation can be performed by using the critical ratios from a decision tree program. Various loads like drills, dimmers, resistors and fluorescent lamps can be tested using the decision tree and various input signals on a test setup that can be configured by one of ordinary skill in the art. The test set up distinguishes the arcing cases from the normal as well as the non-arcing transient cases.

A new decision tree or program for detecting series arcing in residential applications or other applications that series arc detection would be used is provided with the present invention. The combinational use of Wavelet Transforms (which give both time and frequency resolution) and statistical methods allows the decision tree or program to discriminate arcing cases from normal and non-arcing transient cases effectively.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method for detecting a series arc fault in an alternating current electrical signal, comprising:
a) calculating discrete wavelet coefficients using a current signal as an input for the discrete wavelet coefficient calculations, and outputting discrete wavelet coefficient filtered output;
b) subsampling the discrete wavelet coefficient filtered output and outputting a subsampled output;
c) calculating critical variables from the subsampled output;
d) determining from the critical variables whether a series arc fault is present in the current signal; and
e) outputting a signal indicating that a series arc fault is present in the current signal, if substantially all of the critical variables meet a predetermined criteria.

2. The method of claim 1 further comprising:
f) outputting a signal indicating that the series arc fault is not present in the current signal, if one or more of the critical variables do not meet the predetermined criteria.

3. The method of claim 2 further comprising repeating a) through e).

4: The method of claim 1 further comprising, before a), passing the current signal through a filter to provide a filtered current signal.

5: The method of claim 1 wherein the discrete wavelet coefficient calculations comprises sub-sampling and filtering calculations.

6: the method of claim 1 wherein the discrete wavelet coefficient filtered output comprises decomposition and reconstruction discrete wavelet filtered output.

7: The method of claim 1 wherein the subsampled output comprises a subsampled signal with changed time and frequency resolutions as compared to the discrete wavelet coefficient filtered output used in the subsampling calculation.

8: The method of claim 1 wherein critical variables from the subsampled output comprises:
a first critical variable substantially equal to the range of detail coefficient divided by a norm of the fundamental component;
a second critical variables substantially equal to the range of detail coefficient divided by an RMS value of the fundamental component; and
a third critical variables substantially equal to the range of detail coefficient divide by a maximum value of the fundamental component; and
a fourth critical variable substantially equal to a range of detail coefficient divided by a fundamental component of the input signal.

9: A method of detecting a series arc fault in an alternating current electrical signal, the method comprising:
a) obtaining a sampled of the alternating current electrical signal for mathematical analysis;
b) filtering the sampled alternating current electrical signal to remove electrical noise;
c) calculating discrete wavelet coefficients using wavelet decomposition;
d) reconstructing the alternating current electrical signal and fundamental component associated with a predetermined discrete wavelet coefficient;
e) calculating a critical ratio; and
f) detecting a series arc fault in the alternating current electrical signal by using the critical ratio as a threshold to compare to the alternating current electrical signal.

10: A computer program product comprising: a program storage device readable by a circuit interrupter, tangibly embodying a program of instructions executable by the circuit interrupter to perform a method of detecting a series arc fault in an alternating current electrical signal, the method comprising:
a) calculating discrete wavelet coefficients using a current signal as an input for the discrete wavelet coefficient calculations, and outputting discrete wavelet coefficient filtered output;
b) subsampling the discrete wavelet coefficient filtered output and outputting a subsampled output;
c) calculating critical variables from the subsampled output;
d) determining from the critical variables whether a series arc fault is present in the current signal; and
e) outputting a signal indicating that a series arc fault is present in the current signal, if substantially all of the critical variables meet a predetermined criteria.
